(19) United States
(12) Patent Application Publication
(10) Pub. No.: US 2012/0131079 A1
(43) Pub. Date: May 24, 2012

(54) METHOD AND DEVICE FOR COMPUTING MATRICES FOR DISCRETE FOURIER TRANSFORM (DFT) COEFFICIENTS

(76) Inventor: Ngoc Vinh Vu, Victoria (AU)

(21) Appl. No.: 13/063,166

(22) PCT Filed: Sep. 10, 2009
(86) PCT No.: PCT/AU2009/001190

§ 371 Date: May 27, 2011

(30) Foreign Application Priority Data
Sep. 10, 2008 (AU) 2008904721

(51) Int. Cl. G06F 17/14; G06F 17/16

(52) U.S. Cl. 708/315; 708/404

(57) ABSTRACT

A method of computing matrices of discrete-frequency Discrete Fourier Transform (DFT) coefficients, the method including the steps of (a) for a first frame (10) of samples, multiplying a frame of samples of a discrete-time signal by a twiddle factor matrix (F1, F2) to compute a matrix of DFT coefficients for that first frame, and storing a computation resulting from multiplication of the second half of the frame (b) of samples by the right half (F2) of the twiddle factor matrix; and (b) for each subsequent frame (12, 14) of samples, wherein each subsequent frame overlaps a preceding frame by half, (i) retrieving the stored computation from the preceding frame, inverting the sign of the stored computation every second frame; (ii) multiplying the second half of the current frame of samples by the right half of the twiddle factor matrix, and storing the resultant computation; and (iii) adding the results of steps (i) and (ii).

### FIELD OF THE INVENTION

The present invention relates generally to the processing of discrete-time sequences by use of a Discrete Fourier Transform (DFT), and in particular to the computation of DFT coefficients.

### BACKGROUND OF THE INVENTION

The Fourier Transform plays a fundamental role in the processing of signals. It enables the production of a frequency domain representation from an original time-domain signal. In Digital Signal Processing (DSP), signals are represented as discrete-time sequences and thus a specific form of fourier Transform, the Discrete Fourier Transform (DFT), is used. In 1965, Cooley and Tukey first proposed an efficient algorithm, called the Fast Fourier Transform (FFT) to generate a DFT in software. Their original work has been widely expanded on and the term FFT now covers a range of software algorithms for the computation of a DFT.

Typically, the complexity of a DSP algorithm is measured in terms of how many multiplications are required for its implementation. A multiplication count is used in this context as it is the most commonly used complex operation in DSP functions and hence often provides the best representation of an algorithm's execution time on a single processor computer. When considering the efficiency of a hardware implementation, an algorithm is evaluated more on the complexity of the communication required between arithmetic elements rather than the number of computations. FFT algorithms use a butterfly block to reduce the number of multiplications selected but, when considering hardware implementations, the control section of the implementation and the interconnections are complex, leading to significant hardware resources required for implementation. Thus, current FFT-like algorithms are not particularly well suited for Field Programmable Gate Array (FPGA) implementation. Furthermore, whilst some direct implementations of DFT in a FPGA are reasonably straight forward, they generally produce long latency.

Accordingly, it would be desirable to provide a method of computing DFT coefficients that save hardware resources and/or minimise latency when implemented in hardware, such as an FPGA implementation. Moreover, it would be desirable to provide a method of computing matrices of DFT coefficients that ameliorates or overcomes one or more disadvantages or inconveniences of known DFT coefficient computation methods.

### BRIEF SUMMARY OF THE INVENTION

One aspect of the invention provides a method of computing matrices of discrete-frequency Discrete Fourier Transform (DFT) coefficients, the method including the steps of:
(a) for a first frame of samples,
   multiplying a frame of samples of a discrete-time signal by a twiddle factor matrix to compute a matrix of DFT coefficients for that first frame, and
   storing a computation resulting from multiplication of the second half of the frame of samples by the right half of the twiddle factor matrix; and
(b) for each subsequent frame of samples, wherein each subsequent frame overlaps a preceding frame by half,
   (i) retrieving the stored computation from the preceding frame, inverting the sign of the stored computation every second frame;
   (ii) multiplying the second half of the current frame of samples by the right half of the twiddle factor matrix, and storing the resultant computation; and
   (iii) adding the results of steps (i) and (ii).

The above described method takes advantage of the symmetrical properties of a twiddle factor matrix, to infer half the computations that would otherwise be required to compute DFT coefficients for any frame from computations made in respect of a preceding frame, where consecutive frames of samples of a discrete-time signal overlap by half. By providing a memory device in which to store these computations, the method can be performed in an FPGA implementation such that the computation latency is reduced by half. In hardware implementations in which both real DFT coefficients and imaginary DFT coefficients are implemented by this method, the computation latency can be reduced by a factor of 4.

The method may further include the step of using convolution to perform a windowing function to the DFT coefficients in the frequency domain by storing nonzero values of the windowing function, and applying the nonzero values to the DFT coefficients. The windowing function may be a Hamming window. By using convolution in the frequency domain, the memory requirement to store samples of the window can be omitted. Moreover, the original frame P is reserved, such that the first DFT coefficient presents the true energy value of the input frame. This is a required and important value in many DSP algorithms, which if using a time domain windowing method must be calculated separately.

In one or more embodiments of the invention, the steps of the above described method may be performed a first time to compute matrices of real DFT coefficients for twiddle factor matrices comprising real twiddle factor values, and a second time to compute matrices of imaginary DFT coefficients for twiddle factor matrices comprising the imaginary twiddle factor values.

In such embodiments, the step of multiplying the second half of the current frame of samples by the right half of the twiddle factor matrix may be performed by:

performing the multiplications involving real twiddle factors forming one of a top or a bottom half of the right half of the real twiddle factor matrix;

performing the multiplications involving imaginary twiddle factors forming one of a top or a bottom half of the right half of the imaginary twiddle factor matrix;

for real twiddle factors forming the other of the top or bottom half of the right half of the real twiddle factor matrix, inferring the result of the multiplication from a corresponding multiplication in said one of the top or a bottom half of the right half of the real or imaginary twiddle factor matrix; and

for imaginary twiddle factors forming the other of the top or bottom half of the right half of the imaginary twiddle factor matrix, inferring the result of the multiplication from a corresponding multiplication in said one of the top or a bottom half of the right half of the real or imaginary twiddle factor matrix.

Another aspect of the invention provides a device for computing matrices of Discrete Fourier Transform (DFT) coefficients, the device including:

a computation block adapted to, for a first frame of samples, multiply a frame of samples of a discrete-time signal by a twiddle factor matrix to compute a matrix of DFT coefficients for that first frame; and

a memory device for storing a computation resulting from multiplication of the second half of the frame of samples by the right half of the twiddle factor matrix,

wherein the computation block is further adapted, for each subsequent frame of samples, wherein each subsequent frame overlaps a preceding frame by half,
(i) to retrieve the stored computation from the preceding frame, inverting the sign of the stored computation every second frame;
(ii) to multiply the second half of the current frame of samples by the right half of the twiddle factor matrix, and store the resultant computation; and
(iii) add the results of steps (i) and (ii).

The computation block may include a multiply-accumulate (MAC) block for performing matrix multiplication.

The device may further include a convolution block for performing a windowing function to the DFT coefficients in the frequency domain, the convolution block including
a memory unit for storing nonzero values of the windowing function; and
a multiply-accumulate (MAC) block for applying the nonzero values to the DFT coefficients.

The device may further include a first computation block adapted to, for a first frame of samples, multiply a frame of samples of a discrete-time signal by a first twiddle factor matrix comprising real twiddle factor values to compute a matrix of real DFT coefficients for that first frame;

a first memory device for storing a first computation resulting from multiplication of the second half of the frame of samples by the right half of the first twiddle factor matrix comprising real twiddle factor values;

wherein each subsequent frame overlaps a preceding frame by half, and wherein the first computation block is further adapted, for each subsequent frame of samples,
(i) to retrieve the stored first computation from the preceding frame, inverting the sign of the stored first computation every second frame,
(ii) to multiply the second half of the current frame of samples by the right half of the first twiddle factor matrix, and storing the resultant computation, and
(iii) add the results of steps (i) and (ii);

a second computation block adapted to, for the first frame of samples, multiply the frame of samples of a discrete-time signal by a second twiddle factor matrix comprising imaginary twiddle factor values to compute a matrix of imaginary DFT coefficients for that first frame; and

a second memory device for storing a second computation resulting from multiplication of the second half of the frame of samples by the right half of the second twiddle factor matrix comprising imaginary twiddle factor values,

wherein the second computation block is further adapted, for each subsequent frame of samples,
(iv) to retrieve the stored second computation from the preceding frame, inverting the sign of the stored second computation every second frame,
(v) to multiply the second half of the current frame of samples by the right half of the imaginary twiddle factor matrix, and store the resultant computation; and
(vi) add the results of steps (iv) and (v).

Each computation block in such a device may include a multiply-accumulate (MAC) block for performing matrix multiplication.

The device may further include a first convolution block for performing a windowing function to the real DFT coefficients in the frequency domain, and

a second convolution block for performing a windowing function to the imaginary DFT coefficients in the frequency domain,

wherein each convolution block includes
a memory unit for storing nonzero values of the windowing function; and
a multiply-accumulate (MAC) block for applying the nonzero values to the DFT coefficients.

In one of more embodiments, the first computation block may be configured to perform the multiplications involving real twiddle factors forming one of a top or a bottom half of the right half of the real twiddle factor matrix, and the second computation block may be configured to perform the multiplications involving imaginary twiddle factors forming one of a top or a bottom half of the right half of the imaginary twiddle factor matrix. In this case, the device may further include:

a first adder configured, for real twiddle factors forming the other of the top or bottom half of the right half of the real twiddle factor matrix, to add to the first memory device the result of the multiplication from a corresponding multiplication in said one of the top or a bottom half of the right half of the real or imaginary twiddle factor matrix; and

a second adder configured, for imaginary twiddle factors forming the other of the top or bottom half of the right half of the imaginary twiddle factor matrix, to add to the second memory device the result of the multiplication from a corresponding multiplication in said one of the top or a bottom half of the right half of the real or imaginary twiddle factor matrix.

### BRIEF DESCRIPTION OF THE DRAWINGS

Preferred embodiments of the invention are described, by way of example and not by way of limitation, with reference to the accompanying drawings, in which:

FIG. 1 is a schematic diagram illustrating consecutive frames of sample of a discrete-time signal, and the overlapping nature of those consecutive frames of samples;

FIG. 2 is a diagram depicting symmetrical properties of a twiddle factor matrix used in the computation of Discrete Fourier Transform coefficients;

FIG. 3 is an embodiment of a Field Programmable Gate Array implementation of a device computing Discrete Fourier Transform coefficients;

FIG. 4 is a schematic diagram of a portion of a convolution block forming part of the device in shown on FIG. 3;

FIG. 5 is a diagram depicting further symmetrical properties of the twiddle factor matrix used in computation of Discrete Fourier Transform coefficients;

FIG. 6 is a graphical representation of four symmetrical points in a z-plane illustrating additional symmetrical properties of the twiddle factor matrix used in the computation of Discrete Fourier Transform coefficients; and

FIG. 7 is a further embodiment of a Field Programmable Gate Array implementation of a device for computing matrices of Discrete Fourier Transform coefficients.

### DETAILED DESCRIPTION OF THE DRAWINGS

A Fourier Transform is the main tool used to represent time variable signals in the frequency domain. Consider a set of N samples of a discrete-time signal {x(n), n=0,1,2, . . . , N-1}. The conventional discrete Fourier transform (DFT) of x(n) is defined by the following expression:

$$f ( k ) = {\sum }_{N = 0}^{N - 1} x ( n ) {e}^{- j ( \frac{2 π kn}{N} )} , k = 0 , 1 , 2 , … , N - 1 \qquad ( 1 )$$

where the symbol j represents the imaginary number \sqrt{−1} and N real data values (in the time domain) transform to N complex DFT values (in the frequency domain).

Since there is a common term, the above definitions are usually simplified by introducing the following symbol:

$$w = {e}^{- j ( \frac{2 π}{N} )} \qquad ( 2 )$$

In this case, w is a scalar-valued quantity called a “twiddle factor” in practice. Equation (1) can then be written in terms of the twiddle factor as

$$f ( k ) = {\sum }_{n - 0}^{N - 1} x ( n ) {w}^{kn} , k = 0 , 1 , 2 , … , N - 1 \qquad ( 3 )$$

The DFT coefficients defined in Equation (1) can be expressed in matrix-vector form as

$$[ \begin{matrix}f ( 0 ) \\ f ( 1 ) \\ f ( 2 ) \\ ⋮ \\ f ( N - 1 )\end{matrix} ] = [ \begin{matrix}1 & 1 & 1 & … & 1 \\ 1 & w & {w}^{2} & … & {w}^{N - 1} \\ 1 & {w}^{2} & {w}^{4} & … & {w}^{2 ( N - 1 )} \\ ⋮ & ⋮ & ⋮ & ⋱ & ⋮ \\ 1 & {w}^{N - 1} & {w}^{2 ( N - 1 )} & … & {w}^{( N - 1 ) ( N - 1 )}\end{matrix} ] [ \begin{matrix}x ( 0 ) \\ x ( 1 ) \\ x ( 2 ) \\ ⋮ \\ x ( N - 1 )\end{matrix} ] \qquad ( 4 )$$

or

f=Fx (5)

where x is the vector of N input samples and f is the vector of DFT transform coefficients, F being an N×N Fourier matrix. The important role that DFT plays in the analysis, synthesis, and implementation of digital signal processing algorithms is well known to those skilled in the art.

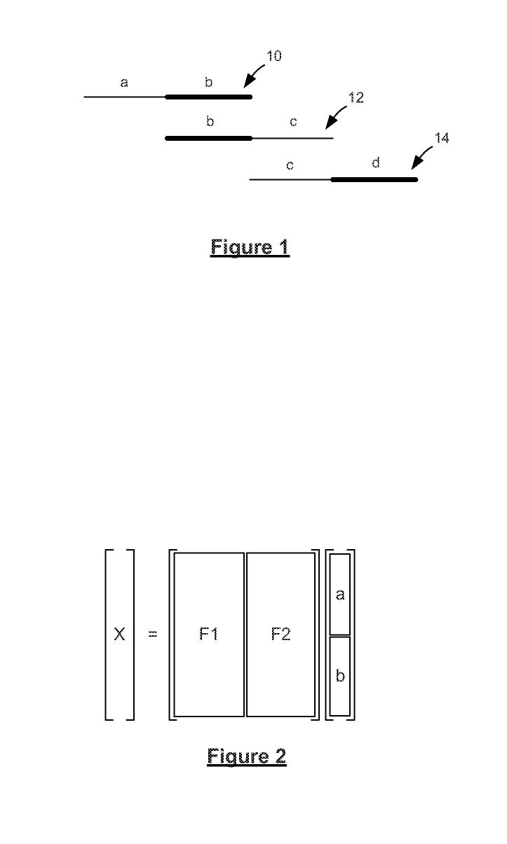

When processing long, non-stationary signals, it is necessary to divide them into short quasi-stationary frames in order to apply Fourier analysis. To avoid spectral leakage and missed events, should they occur near frame boundaries, input signal frames are overlapped and an appropriate windowing function is applied to reduce frame boundary effects. FIG. 1 illustrates an example of three consecutive frames 10, 12 and 14 of samples of a discrete-time signal. Each frame has N elements referenced x[n], where n runs from 0 to N-1. Each frame overlaps a preceding frame by half or 50%.

Whilst the DFT transform coefficients in Equation (4) are complex, in practice both real and imaginary DFT coefficients are computed in hardware implementations of DFT algorithms. The resultant real and imaginary DFT coefficients then used to compute complex DFT coefficients. The simplest formulas used to calculate real and imaginary DFT coefficients are as follows:

$$\begin{matrix}{X}_{Re} [ k ] = {\sum }_{n = 0}^{N - 1} x [ n ] cos ( \frac{2 π kn}{N} ) & ( 6 ) \\ {X}_{Im} [ k ] = - {\sum }_{n = 0}^{N - 1} x [ n ] sin ( \frac{2 π kn}{N} ) & ( 7 )\end{matrix}$$

where X_{Re}[k] and Xᵢₘ[k] are the real and imaginary DFT coefficients at bin index k, where N is size of the DFT.

As the input signal is normally purely real, the complex output of the DFT will be symmetric and only values from k+0-N/2−1 are required, while n uses the values 0 to N-1.

The two Equations (6) and (7) can be implemented in FPGA hardware in a direct manner using with two Multiply-Accumulate (MAC) blocks. This is particularly attractive as MAC blocks are now commonly found embedded in low-cost FPGA chips. For example, the low-cost FPGA Spartan-3 family from

Xilinx includes more than 30 MAC blocks.

Both Equations (6) and (7) can be described in matrix form as follows:

Xₖ=[F][xₙ] (8)

where F is the matrix form of a cosine or sine table (twiddle factors matrix), and Xₙ is the input signal. Based on Equation (8), the Fourier Transform of the frame 10 is as follows:

X₁ₖ=[F][xₙ]=[F][ab] (9)

If the matrix F is perpendicularly divided into a left half F1 and a right half F2 so that F=[F1 F2], as shown in FIG. 2, Equation (4) will become

X₁ₖ=[F][xₙ]=[F][ab]=[F1][a]+[F2][b] (10)

Similarly, the Fourier transform of the frame 12 and frame 14 in FIG. 1 is described by Equations (11) and (12) respectively.

X₂ₖ=[F1][b]+[F2][c] (11)

X₃ₖ=[F1][c]+[F2][d] (12)

Also from Equations (6), (7) and (8), it can be seen that

$$F = cos ( \frac{2 π kn}{N} ) orF = sin ( \frac{2 π kn}{N} )$$

where k=0: N/2−1 and n=0: N-1

In the case where

$$F = cos ( \frac{2 π kn}{N} ) ,$$

F1 and F2 in Equations (10), (11) and (12) are indicated in Equations (12a) and (12b) as follows:

$$\begin{matrix}F 1 = cos ( \frac{2 π kn}{N} ) \\ Where k = 0 : N \text{/} 2 - 1 and n = 0 : N \text{/} 2 - 1 \\ and & ( 12 a ) \\ F 2 = cos ( \frac{2 π kn}{N} ) \\ Where k = 0 : N and n = N \text{/} 2 : N - 1 & ( 12 b )\end{matrix}$$

If n varies from 0 to N/2−1, F2 will become

$$F 2 = cos ( \frac{2 π k ( n + \frac{N}{2} )}{N} ) = cos ( \frac{2 π kn}{N} + π k ) = \pm F 1 \qquad ( 13 )$$

Equation 13 shows that F2=±F1 depending on k, which is still true when

$$F = sin ( \frac{2 π kn}{N} ) .$$

As described in Equations (10) and (11), the DFT coefficients of frame 10 are determined by [F1][a] and [F2][b], and the DFT coefficients of frame 12 are [F1][b] and [F2][c]. However, since F2=±F1 (as shown above), so [F1][b] can be inferred from [F2][b] without any further computation, and the values contained in [F2][b] need only be stored for the next round of computation. Hence, the required computation of frame 12 can be reduced by a factor of two. Similarly, in the calculation of the DFT for frame 14, only [F2][d] requires specific computation. Consequently, after the first frame, the computational requirements of each subsequent frame can be reduced by 50%.

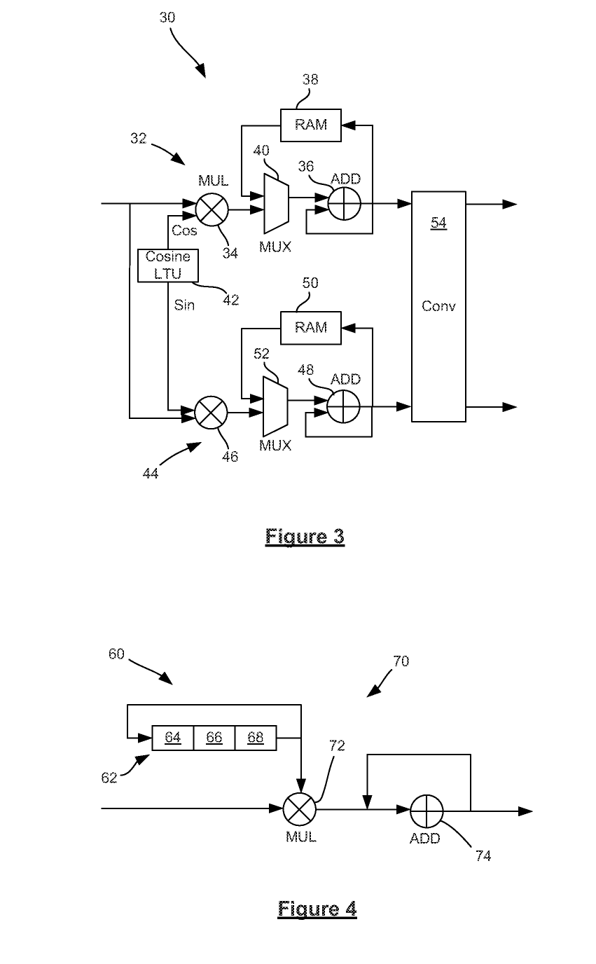

The above described technique can be implemented in hardware as shown in FIG. 3. This figure depicts a device 30 for computing DFT coefficients. The device 30 includes a first computation block adapted to multiply frames of sample of a discrete-time signal by a twiddle factor matrix to computer matrix of DFT coefficients for those frames. To that end, the computation block 32 includes a Multiply-Accumulate (MAC) block including a multiplier 34 and an adder 36. The computation block 32 further includes a memory device 38 and a multiplexer 40. The device 30 further includes a look-up table 42 storing twiddle factors required for the computation block 32 to perform the computation described by Equation (6).

In operation, each input signal sample of the first frame 10 is multiplied by the multiplier 34 with a real twiddle factor from the look-up table 42 and then accumulated by the adder 36 to compute a matrix of real DFT coefficients for that first frame 10. The computation resulting from multiplication of the second half of the frame of samples by the right half of the twiddle factor matrix is stored in the memory device 38 at address k, where k is the real DFT bin index.

For the second frame 12 and subsequent frames of samples of the discrete-time input signal, half of the computation for the real DFT coefficients for this second frame 12 is already available, having previously been stored in the memory device 38. Accordingly, the stored computation from the preceding frame is retrieved, and the sign of the stored computation is inverted for every second frame. The second half of the current frame 12 of samples is then multiplied by the right half of the twiddle factor matrix maintained in the look-up table 42, and the results of that multiplication are then added to the retrieved computation by the adder 36 so as to produce the DFT coefficients for that next bin.

The computation resulting from multiplication of the second half of the current frame of samples by the right half of the twiddle factor matrix is stored in the memory device 38 at address k+1. This process is repeated until the real DFT coefficients have been computed for all bins.

In this embodiment, the device 30 further includes a second computation block 44 including a MAC block in the form of a multiplier 46 and an adder 48, as well as a second memory device 50 and multiplexer 52. Whereas the first computation block 32 and first memory device 38 use the frames of samples of the discrete-time input signal and real twiddle factor values maintained in the look-up table 42 to compute real DFT coefficients for the frames of samples, the second computation block 44 and second memory device 42 use the frames of samples of input signals and imaginary twiddle factor values maintained in the look-up table 42 to compute imaginary DFT coefficients for the various frames of samples.

To that end, the second computation block 44, for a first frame 10 of samples, multiplies the frame of samples by the imaginary twiddle factor values maintained in the look-up table 42 to compute imaginary DFT coefficients for that first frame. The computation resulting from multiplication of the second half of the frame of samples by the right half of the twiddle factor matrix comprising imaginary twiddle factor values is stored in the second memory device 50.

For the second frame 12 of samples and subsequent frames, the computation carried out for a preceding frame and stored in the memory device 50 is retrieved, and the sign of the stored computation inverted every second frame. For each current frame, the second half of the current frame of samples is then multiplied by the right half of the imaginary twiddle factor matrix, and the results of the multiplication and retrieved computation are then added to generate an imaginary DFT coefficient for a particular DFT bin. The process is once again repeated until imaginary DFT coefficients have been calculated for all DFT bins. For each second and subsequent frame of samples, the computation resulting from multiplying the second half of the current frame of samples by the right half of the imaginary twiddle factor matrix is stored in the memory device 50 for use in computations relating to the subsequent frame.

Each of the memory devices 38 and 50 may comprise a dual port random access memory (RAM) with two independent ports allowing a single memory space to be shared. The dual port RAM space may be divided into two equal parts, each of which has a size of N/2 (N being the size of the DFFT). In this case, the dual port RAM operates like a circular buffer, so that while one part is occupied by a DFT block, the other is filled by input signal samples.

To reduce spectral leakage in the computation of DFT coefficients, a window function is usually applied to the time-domain input signal. However, applying the window function in the time-domain would compromise asymmetrical properties utilised in the device 30 shown in FIG. 3, and the computations stored in the memory devices 38 and 50 from previous frames would no longer be valid. Accordingly, the device 30 further includes a convolution block 54 which applies a windowing function to the real and imaginary DFT coefficients in the frequency domain.

Although a variety of windowing functions can be implemented by the convolution block 54, two examples which have the advantage of being simple to generate are Hann and Hamming windows. A Hamming window can be considered as a modified Hann window which achieves more side lobe cancellation. A Hamming window can be described as the sum w(n) of sequences:

$$w ( n ) = a + ( 1 - a ) cos [ \frac{2 π}{N} n ] \qquad ( 14 )$$

where N is the size of the window (normally is the same as DFT siz), α is normally an integer and N is an index of value 0 to N-1.

A DTFT (Discrete Time Fourier transform) of each sequence can be identified as:

$$\begin{matrix}W ( θ ) = aD ( θ ) + 0.5 ( 1 - a ) [ D ( θ - \frac{2 π}{N} ) + D ( θ + \frac{2 π}{N} ) ] \\ where & ( 15 ) \\ D θ = exp ( + i \frac{θ}{2} ) \frac{sin [ \frac{N}{2} θ ]}{sin [ \frac{1}{2} θ ]} & ( 16 )\end{matrix}$$

In case of a DFT, the window is sampled at multiples of

$$\frac{2 π}{N} .$$

Consequently, only three nonzero samples are taken during the sample process. The position of those samples are at

$$- \frac{2 π}{N} ,$$

0, and

$$\frac{2 π}{N} ,$$

with the corresponding value of the samples obtained from being −(1-α)/2, α and −(1-α)/2. α has a value of 0.54 and thus, the DFT of the Hamming window only comprises three nonzero values, −0.23, 0.54, and −0.23.

By using convolution in the frequency domain, the memory requirement to store samples of the windowing function can be omitted. Moreover, the original frame is reserved, such that the first DFT coefficient presents the true energy value of the input frame. Since this is a required and important value in many digital signal processing algorithms, which if using a time-domain windowing method must be calculated separately, using convolution in the frequency domain achieves further resource savings in the hardware implementation shown in FIG. 3.

FIG. 4 shows a convenient matter in which the windowing function provided by the convolution block 54 can be provided. This hardware implementation 60 includes a shift register 62 including three memory elements 64, 66 and 68 for storing each of the three nonzero values of the DFT of the hamming window. Each of the three of the nonzero values of the DFT of the hamming window are applied to the real or imaginary DFT coefficients by a MAC block 70 in the form of a multiplier 72 and adder 74. It will be appreciated that the convolution block 54 includes two sets of the elements depicted in FIG. 4, namely a first set for applying the windowing function to the real DFT coefficients generated at the output of the adder 36 and a second set for applying the windowing function to the imaginary DFT coefficients at the output of the adder 48.

The embodiment of the invention depicted in FIGS. 3 and 4 takes advantage of the symmetrical properties of twiddle factor matrices to save computational complexity. However, further latency savings can be achieved through the use of an optimization technique based upon these same symmetrical properties with only a minor hardware addition.

Where F is the twiddle factors matrix, it also has complex formula: F=W_{N}^{kn}, where the k value is from 0 to N/2−1 and n is from 0 to N-1 As indicated in Equations (10), (11) and (12), F1 is the left half of matrix F where n runs from 0 to N/2−1 and F2 is the right half where n runs from N/2 to N-1.

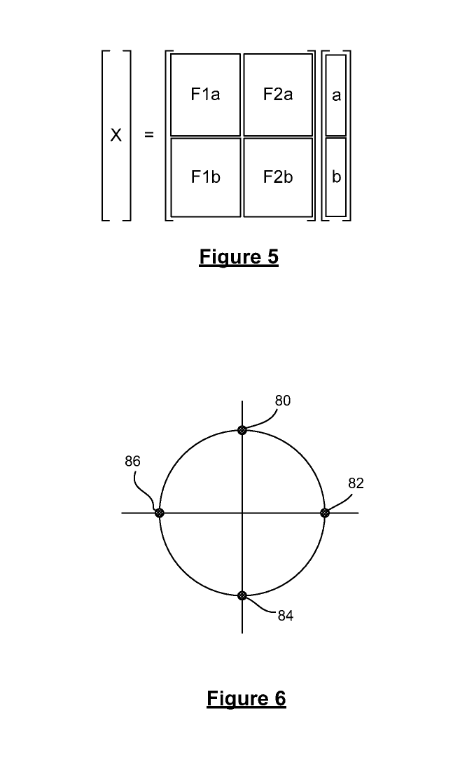

Accordingly, F1=W_{N}^{kn}, where k and n runs from 0 to N/2−1. If we let L=N/2, F1=W_{2L}^{kn}, where k and n run from 0 to L-1. As shown in FIG. 5, if F1 is divided horizontally in to F₁ₐ and F_{1b}, then F₁ₐ=W_{2L}^{kn}, where k runs from 0 to L/2−1 and n runs from 0 to L-1 and F_{1b}=W_{2L}^{kn}, where k runs from L/2 to L-1 and n runs from 0 to L-1.

If k runs from 0 to L/2−1, F_{1b} can be expressed by

$$\begin{matrix}{F}_{1 b} = {W}_{2 L}^{( k + \frac{L}{2} ) n} = {W}_{2 L}^{kn} {W}_{2 L}^{\frac{nL}{2}} = {F}_{1 a} {W}_{2 L}^{\frac{nL}{2}} \\ where & ( 17 ) \\ {W}_{2 L}^{\frac{nL}{2}} = {e}^{\frac{- i2π \frac{nL}{2}}{2 L}} = {e}^{\frac{- i n π}{2}} & ( 18 )\end{matrix}$$

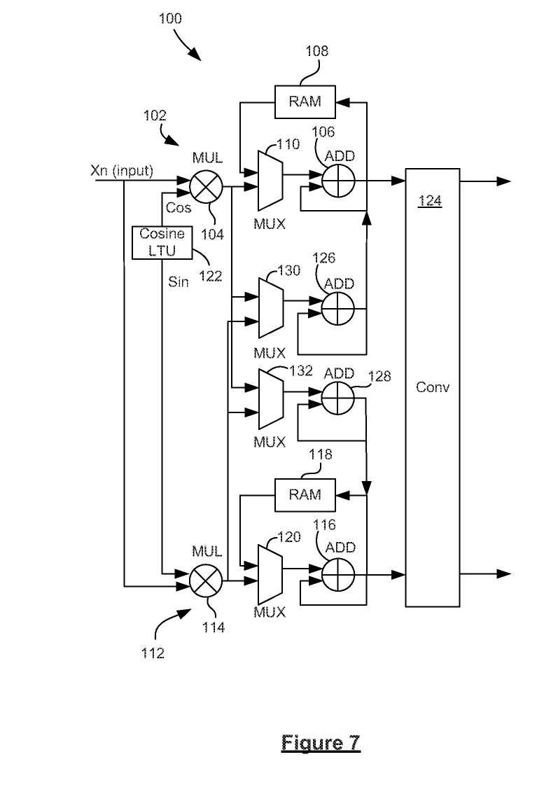

The equation (18) presents four symmetrical points 80 to 86 in the z plane, as shown in FIG. 6.

From the foregoing, the DFT basic Equations (6) and (7) can be rewritten as follows:

$$\begin{matrix}{X}_{Re} [ k ] = {\sum }_{n = 0}^{N - 1} x [ n ] cos ( \frac{2 π kn}{N} ) , \\ where k run from 0 to N \text{/} 4 - 1 & ( 19 ) \\ {X}_{Re} [ k + \frac{N}{4} ] = {\sum }_{n = 0}^{N - 1} x [ n ] A , \\ where A = \pm cos ( \frac{2 π kn}{N} ) or \pm sin ( \frac{2 π kn}{N} ) dependent on k & ( 20 ) \\ {X}_{Im} [ k ] = - {\sum }_{n = 0}^{N - 1} x [ n ] sin ( \frac{2 π kn}{N} ) , \\ where k run from 0 to N \text{/} 4 - 1 \\ {X}_{Im} [ k + \frac{N}{4} ] = - {\sum }_{n = 0}^{N - 1} x [ n ] A , \\ where & ( 21 ) \\ A = \pm cos ( \frac{2 π kn}{N} ) or \pm sin ( \frac{2 π kn}{N} ) dependent on k . & ( 22 )\end{matrix}$$

As a result, when computing a DFT coefficient at index k, the product of the two multiplications can be swapped with an appropriate sign bit depending on index k to compute a DFT coefficient at index k+L/2. Therefore, instead of looping N/2 times to calculate all the bins of DFT coefficients, looping is only required for N/4 times with the addition of only two more adders, as illustrated in FIG. 7.

In other words, in order to multiply the second half b of the frame of samples by the right half F2 of the real and imaginary twiddle factor matrices, only multiplications involving twiddle factors forming one of a top half F2a or a bottom half F2b of the right half F2 of the real and imaginary twiddle factor matrices need be computed. For real twiddle factors forming the other of the top half F2a or bottom half F2b of the right half F2 of the real twiddle factor matrix, the result of the multiplication can be inferred from a corresponding multiplication in said one of the top half F2a or a bottom half F2b of the right half F2 of the real or imaginary twiddle factor matrices.

FIG. 7 depicts a device 100 for computing real and imaginary DFT coefficients which implements the optimisation technique described in relation to FIGS. 5 and 6. The device 100 includes a first computation block 102 including a MAC block in the form of a multiplier 104 and adder 106. A first memory device 108 and associated multiplexer 110 is also included. The device 100 further includes a second computation block 112 including a MAC block in the form of a multiplier 114 and adder 116. A second memory device 118 and associated multiplexer 120 is also included. Moreover, the device 100 includes a look-up table 122 and convolution block 124. The first and second computation blocks 102 and 112, the first and second memory devices 108 and 118 and associated multiplexers 110 and 120, the look-up table 130 and convolution block 124 function in a manner similar to that described in relation to the first and second computation blocks 32 and 44, first and second memory devices 38 and 50 and associated multiplexers 40 and 52, look-up table 42 and convolution block 54 described in relation to the device 30 shown in FIG. 3.

In the device 100, the first computation block 102 is configured to perform the multiplications involving real twiddle factors forming one of a top half F2a or a bottom half F2b of the right half F2 of the real twiddle factor matrix. Similarly, the second computation block 112 is configured to perform the multiplications involving imaginary twiddle factors forming one of a top half F2a or a bottom half F2b of the right half F2 of the imaginary twiddle factor matrix.

However, the device 100 further includes additional adders 126 and 128 and additional multiplexers 130 and 132. The adder 126 is configured, for real twiddle factors forming the other of the top half F2a or bottom half F2b of the right half F2 of the real twiddle factor matrix, to add to the first memory device 108 the result of the multiplication from a corresponding multiplication in the one of the top or a bottom half of the right half of the real or imaginary twiddle factor matrix as provided by the multiplexer 130. Similarly, the adder 128 is configured, for imaginary twiddle factors forming the other of the top half F2a or bottom half F2b of the right half F2 of the imaginary twiddle factor matrix, to add to the second memory device 118 the result of the multiplication from a corresponding multiplication in the one of the top or a bottom half of the right half of the real or imaginary twiddle factor matrix as provided by the multiplexer 132. In this way, instead of looping N/2 times to calculate all the required DFT coefficients, looping is required only N/4 times in the device 100 by the addition of the adders 126 and 128 and associated multiplexers 130 and 132, thereby providing further latency savings compared to the device 30 shown in FIG. 3.

It is to be understood that the above described elements are merely illustrative of the invention disclosed herein and that many variations may be devised and created by those skilled in the art without departing from the spirit of the invention.

1-14. (canceled)

15. A method of computing matrices of discrete-frequency Discrete Fourier Transform (DFT) coefficients, the method including the steps of:
(a) for a first frame of samples,
multiplying a frame of samples of a discrete-time signal by a twiddle factor matrix to compute a matrix of DFT coefficients for that first frame, and
storing a computation resulting from multiplication of the second half of the frame of samples by the right half of the twiddle factor matrix; and
(b) for each subsequent frame of samples, wherein each subsequent frame overlaps a preceding frame by half,
(i) retrieving the stored computation from the preceding frame, inverting the sign of the stored computation every second frame;
(ii) multiplying the second half of the current frame of samples by the right half of the twiddle factor matrix, and storing the resultant computation; and
(iii) adding the results of steps (i) and (ii).

16. A method according to claim 15, wherein the DFT matrices comprise real DFT coefficients and each twiddle factor matrix comprises real twiddle factor values.

17. A method according to claim 15, wherein the DFT matrices comprise imaginary DFT coefficients and each twiddle factor matrix comprises imaginary twiddle factor values.

18. A method according to claim 15, and further including the step of using convolution to perform a windowing function to the DFT coefficients in the frequency domain by:
storing nonzero values of the windowing function; and
applying the nonzero values to the DFT coefficients.

19. A method according to claim 18, wherein the windowing function is a Hamming window.

20. A method of computing matrices of discrete-frequency Discrete Fourier Transform (DFT) coefficients, the method including the steps of:
performing steps (a) and (b) of claim 15 to compute matrices of real DFT coefficients for twiddle factor matrices comprising real twiddle factor values; and
performing steps (a) and (b) of claim 15 to compute matrices of imaginary DFT coefficients for twiddle factor matrices comprising imaginary twiddle factor values.

21. A method according to claim 20, wherein step (b) (ii) includes:
performing the multiplications involving real twiddle factors forming one of a top or a bottom half of the right half of the real twiddle factor matrix;
performing the multiplications involving imaginary twiddle factors forming one of a top or a bottom half of the right half of the imaginary twiddle factor matrix;
for real twiddle factors forming the other of the top or bottom half of the right half of the real twiddle factor matrix, inferring the result of the multiplication from a corresponding multiplication in said one of the top or a bottom half of the right half of the real or imaginary twiddle factor matrix; and
for imaginary twiddle factors forming the other of the top or bottom half of the right half of the imaginary twiddle factor matrix, inferring the result of the multiplication from a corresponding multiplication in said one of the top or a bottom half of the right half of the real or imaginary twiddle factor matrix.

22. A device for computing matrices of Discrete Fourier Transform (DFT) coefficients, the device including:
a computation block adapted to, for a first frame of samples,
multiply a frame of samples of a discrete-time signal by a twiddle factor matrix to compute a matrix of DFT coefficients for that first frame; and
a memory device for storing a computation resulting from multiplication of the second half of the frame of samples by the right half of the twiddle factor matrix,
wherein the computation block is further adapted, for each subsequent frame of samples, wherein each subsequent frame overlaps a preceding frame by half,
(i) to retrieve the stored computation from the preceding frame, inverting the sign of the stored computation every second frame;
(ii) to multiply the second half of the current frame of samples by the right half of the twiddle factor matrix, and store the resultant computation; and
(iii) add the results of steps (i) and (ii).

23. A device according to claim 22, wherein the computation block includes a multiply-accumulate (MAC) block for performing matrix multiplication.

24. A device according to claim 22, and further including:
a convolution block for performing a windowing function to the DFT coefficients in the frequency domain, the convolution block including:
a memory unit for storing nonzero values of the windowing function; and
a multiply-accumulate (MAC) block for applying the nonzero values to the DFT coefficients.

25. A device for computing matrices of Discrete Fourier Transform (DFT) coefficients, the device including:
a first computation block adapted to, for a first frame of samples, multiply a frame of samples of a discrete-time signal by a first twiddle factor matrix comprising real twiddle factor values to compute a matrix of real DFT coefficients for that first frame;
a first memory device for storing a first computation resulting from multiplication of the second half of the frame of samples by the right half of the first twiddle factor matrix comprising real twiddle factor values;
wherein each subsequent frame overlaps a preceding frame by half, and
wherein the first computation block is further adapted, for each subsequent frame of samples,
(i) to retrieve the stored first computation from the preceding frame, inverting the sign of the stored first computation every second frame,
(ii) to multiply the second half of the current frame of samples by the right half of the first twiddle factor matrix, and storing the resultant computation, and
(iii) add the results of steps (i) and (ii),
a second computation block adapted to, for the first frame of samples, multiply the frame of samples of a discrete-time signal by a second twiddle factor matrix comprising imaginary twiddle factor values to compute a matrix of imaginary DFT coefficients for that first frame; and
a second memory device for storing a second computation resulting from multiplication of the second half of the frame of samples by the right half of the second twiddle factor matrix comprising imaginary twiddle factor values,
wherein the second computation block is further adapted, for each subsequent frame of samples,
(iv) to retrieve the stored second computation from the preceding frame, inverting the sign of the stored second computation every second frame,
(v) to multiply the second half of the current frame of samples by the right half of the imaginary twiddle factor matrix, and store the resultant computation; and
(vi) add the results of steps (iv) and (v).

26. A device according to claim 25, wherein each computation block includes a multiply-accumulate (MAC) block for performing matrix multiplication.

27. A device according to claim 25, and further including:
a first convolution block for performing a windowing function to the real DFT coefficients in the frequency domain, and
a second convolution block for performing a windowing function to the imaginary DFT coefficients in the frequency domain,
wherein each convolution block includes:
a memory unit for storing nonzero values of the windowing function; and
a multiply-accumulate (MAC) block for applying the nonzero values to the DFT coefficients.

28. A device according to claim 25, wherein the first computation block is configured to perform the multiplications involving real twiddle factors forming one of a top or a bottom half of the right half of the real twiddle factor matrix, and the second computation block is configured to perform the multiplications involving imaginary twiddle factors forming one of a top or a bottom half of the right half of the imaginary twiddle factor matrix, the device further including:
a first adder configured, for real twiddle factors forming the other of the top or bottom half of the right half of the real twiddle factor matrix, to add to the first memory device the result of the multiplication from a corresponding multiplication in said one of the top or a bottom half of the right half of the real or imaginary twiddle factor matrix; and
a second adder configure, for imaginary twiddle factors forming the other of the top or bottom half of he right half of the imaginary twiddle factor matrix, to add to the second memory device the result of the multiplication from a corresponding multiplication in said one of the top or a bottom half of the right half of the real or imaginary twiddle factor matrix.
